(19) United States
(12) Patent Application Publication
(10) Pub. No.: US 2009/0125740 A1
(43) Pub. Date: May 14, 2009

(54) Dual programmable energy saving timer system

(76) Inventors: Steven M. Ragan, Austin, TX (US); Brian D. Cox, Round Rock, TX (US)

Correspondence Address: Michael A. Ervin;[M. A. Ervin & Associates], 8202 Talbot Cove, Austin, TX, 78746, US

(21) Appl. No.: 11/983,670

(22) Filed: Nov. 9, 2007

(51) Int. Cl. G06F 1/32

(52) U.S. Cl. 713/323

(57) ABSTRACT

A dual control programmable energy savings timer is described that provides primary control to a utility provider or other supplier of electrical power but a second level of programmable control to an end user that enables additional power savings to end users of electrical energy.

### FIELD OF INVENTION

This invention relates to a system for controlling power consumption for certain end uses in which different entities have the capacity to program the system to limit energy consumption during chosen periods.

### BACKGROUND OF THE INVENTION

The invention to be described relates to providing a solution to a dual need that occurs in home electric utility systems. The dual need is first that electric utilities need to have a power generating capacity sufficient to supply the peak load on the power generating system. The peak load varies both daily and seasonally and the cost of providing power has a direct relationship with the peak daily load as well as the peak seasonal load. To reduce costs, it is highly desirable, to the extent possible, to transfer power use on a daily basis from the periods of peak load to periods of off-peak load. Simultaneously with this need the end users of these power generating systems (both commercial establishments and individuals) often have a second need, independent of the utility company, to save energy at other times outside of peak load periods, The ability to meet both of those needs in a cost effective and straightforward manner is an aspect of this invention.

An example of an electrical appliance that is particularly suitable for shifting the time that it is energized is the electrical water heater. Because many hot water heaters are well insulated and have large capacity an end-user can draw a significant amount of hot water from the hot water tank even after the heater is de-energized. Thus a utility company that can control the power generation to hot water end-users during peak loads can much more effectively balance their peak generation requirements and save both operating and capital costs.

Kirk, et. al. in U.S. Pat. No. 4,998,024 addresses the peak load issue by describing a programmable timer that is connected to a hot water system and turns off the energized power during certain preprogrammed peak load periods. The end user has only one option in this system, which is to be able to override the power off function once during each peak period for a preprogrammed amount of time. A need that is not addressed at all in the Kirk description is the growing need on the part of end-users to save energy all year long both during peak load and non peak load periods, while still giving the electrical utility company the control of power during peak load periods. This growing need is created by the ever-increasing cost of electrical power as well as the high capital cost of new power generation capability. Thus there is a need to simultaneously allow the utility company to control peak load power while allowing the end-user to significantly reduce energy costs by giving the end user programming capability to de-energize power during the many periods when the end-users might be away from the building which makes use of the hot water system. This dual need is not presently met in any commercial or patented systems.

### SUMMARY OF THE INVENTION

The present invention provides a system for automatically controlling the power applied to an electric water heater so that during certain times, primarily pre-defined peak periods determined by the utility company or an intermediate supplier such as a property owner to be times desired to reduce power load, power is turned off to the water heater. These times are programmed into the controller as a first data set of dates and times. As soon as the peak load period ends, the power is restored to the water heater and the normal thermostat control will resume control of the heating of the water in the water heater in accordance with water temperature. Once the power is restored though, the instant invention allows the end user to have the programming capability through a user interface to set a second level of power control to further save energy during non peak load periods at the discretion of the end user. The user interface allows the end user to provide a second set of data of dates and times. Another aspect of the present invention is an override function that is available once per day that allows the end user to override the first data set's pre-programmed dates and times.

An aspect of the system includes a programmable energy saving timer for use by an end user for delivering power to an end use including at least: a relay for on and off switching of power to the end use; a user interface; and a controller with associated control software connected to the relay, and the user interface; wherein the controller with associated control software operates based on a first data set and a second data set; and wherein the first data set is programmed into the controller by a first entity; and the second data set is programmed into the controller by the end user using the user interface.

Another aspect of the invention is a method of switching on and off a power source to an end use including at least the steps of: providing a first data set of times in which the power is switched off; providing a second data set of times in which the power is switched off; and switching the power source off at times dictated by said first and second data sets; wherein the first data set is provided by a first entity; and the second data set is provided by an end user of the end use.

Another aspect of the system is a tamper protection function that detects and records when either the front panel of the user interface or the enclosure of the controller is opened.

Another aspect of the system is a portable programming unit, that can be used by service personnel to quickly and accurately change the first data set.

Another aspect of the system is a user capability to override the first data set once per day for a prescribed period of time.

Another aspect of the system is a capability to convert the user interface from the English language to Spanish.

### DESCRIPTION OF DRAWINGS

FIG. 1 is a schematic block diagram illustrating a configuration of the invention.

FIG. 2 is perspective view of a user interface of the invention.

FIG. 3 is a perspective view of base unit configuration of the invention.

FIG. 4 illustrates a menu screen display of the programmable energy saving timer user interface viewable to a user and controllable through touch button inputs by a user.

FIG. 5 illustrates another menu screen display of the programmable energy saving timer user interface viewable to a user and controllable through touch button inputs by a user.

FIG. 6 illustrates another menu screen display of the programmable energy saving timer user interface viewable to a user and controllable through touch button inputs by a user.

### DETAILED DESCRIPTION OF THE INVENTION

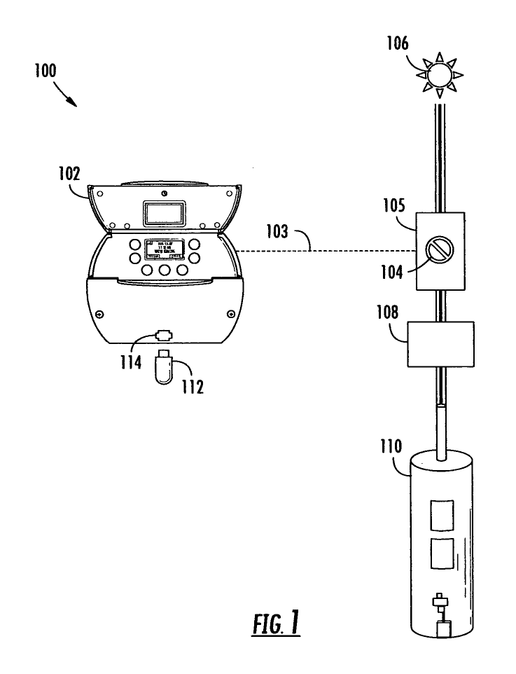

Referring to FIG. 1, a programmable energy saving timer, shown generally as 100, includes a user interface 102 that controls a unit 105 with a relay 104. Relay 104 can switch off the power 106 to a thermostatic control 108 of an appliance 110. Appliance 110 can be for example an electric water heater. Power source 106 can be the power from a utility provider and can be for example a 240V AC source.

The invention can be configured in a number of ways but operation is the same in each. In single-family homes, the National Electrical Code (NEC) code requires that a means of electrical service disconnect is present within sight of the water heater so that electrical power can be verifiably disconnected when the water heater is serviced or replaced. However, the water heater is typically located in a closet, garage or attic where programming is not as convenient. For this type of configuration the timer can consist of two pieces, a base unit 105 mounted near the water heater that has electrical service disconnect capability as well as the relay and a remote unit 102 mounted in a convenient location inside the dwelling space. The remote unit in this configuration serves as a user interface to program the base unit by communicating user commands to the base unit through a wireless link 103 such as for example a radio frequency (RF) link. The base unit 105 receives the programming and then runs it to turn the appliance on and off via as requested by the program. In this configuration most of the intelligence including memory and clock functions could lie in a microprocessor in remote unit 102 or could be shared with microprocessors in both remote 102 and base 104 units.

The base unit is mounted near the water heater; typically in an unheated closet, garage or attic space. Although no user interface is required on the base unit; there can be one or more indicator LED's or other display means that indicate whether or not the base itself is powered and if the controlled appliance is powered. The base unit also includes an integral means of electrical service disconnect as required by code.

A second configuration is possible. A stand-alone integrated module that is mounted at an electrical service panel. In this case the user interface and relay function could be included in a combination of units 102 and 104 and the required electrical service disconnect can be available via normal circuit breakers at the service panel.

An aspect of the programmable energy saving timer is that it is controlled by two different data sets. A data set in this context is a concise set of instructions that determine when the relay of the programmable energy saving timer is to be on and off. The first, and dominant data set is provided not by the end user but by another entity, which could be an electric utility company, or could be, for example, a property owner of a large apartment complex. Electric utilities have a large economic incentive to control power usage during peak load periods. By doing so they can avoid capital investment in excess electrical capacity that is only needed during those peak periods. For many such companies those peak periods are summer afternoons that feature high air conditioning use. Some utility providers offer discounted electric power rates to end users who are willing to cut back on energy use to appliances such as water heaters during these peak loads. For similar reasons, a property owner of a large apartment complex would benefit from being able to reduce energy consumption across a large number of water heaters. Either of these entities, the utility company, or a property owner, could have control over the first data set.

As mentioned, a data set, in the context of the instant invention, is a set of coded software instructions that control when relay 104 will be used to deny power 106 to appliance 110. When no instructions are provided for either the first or second data set, that condition is know as a null set.

The end user provides the second data set in the instant invention. Separately from the first entity, the end user often wants to save energy, and appliances such as the electric water heater (or a pool timer, water sprinkler, etc.) offer an opportunity to do so if the functionality is available. This second data set is programmable by the end user directly from user interface 102. The second data set is subservient to the first data set. The end user cannot reprogram the first data set. However, there are many opportunities through the year for the end user to supply programming through the second data set that will save energy (and cost) for the end user. These will be periods when the end user knows, based on his/her living, traveling, and vacationing patterns, that they could save significantly by making use of the second data set to save electric power.

Because it is recognized that occasionally an end user may require a large amount of hot water during a peak load period a provision is available in the instant invention for an occasional override or by pass of the first data set instructions. This override capability is limited by the software to one time per day and to a prescribed period, for example one hour.

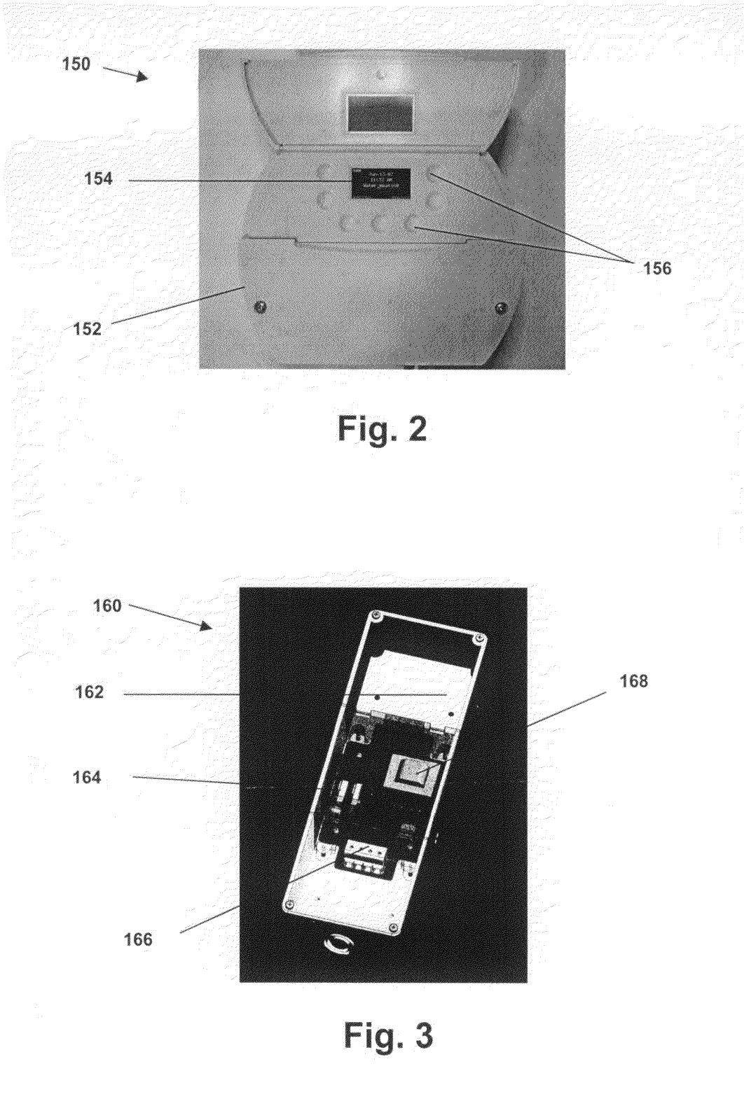

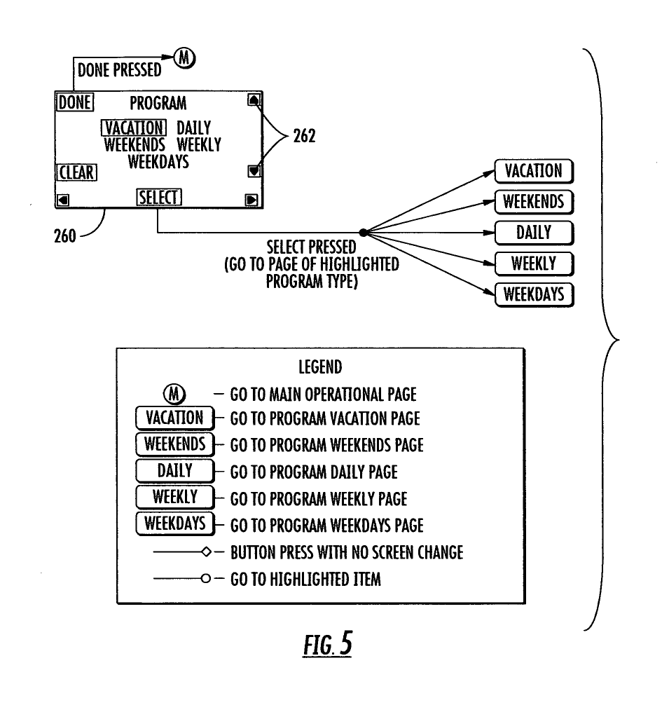

FIG. 2, represented generally by the numeral 150 is a perspective view of a user interface (such as 102 of FIG. 1) of a programmable energy saving timer. An enclosure 152 protects the electronics. A menu screen 154 displays the instructions available to an end user. Buttons 156 surrounding the menu screen provide input functions for the end user. The possibilities for programming are described in more detail in FIGS. 4-6.

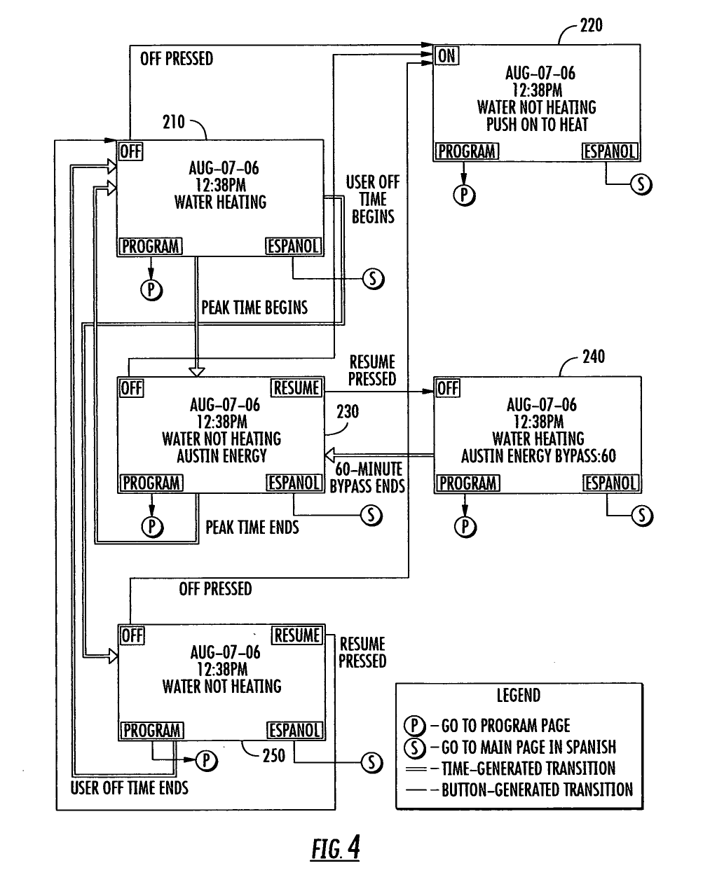

FIG. 3, represented generally by the numeral 160 is a perspective view of a base unit (such as 105 of FIG. 1) of a programmable energy saving timer. An enclosure 162 protects the internals, which include an electrical service disconnect 164 and the control electronics 168. The relay (104 of FIG. 1) is not visible in FIG. 3 but is also included in such a base unit.

FIG. 4 exhibits, via a series of menu screen displays, the operation of the user interface in a preferred embodiment of the instant invention if it is being used to heat water. It is assumed in FIG. 4 that the end user has already programmed the energy saving timer so there is a second data set available to the controller defining prescribed times of energy savings. A first display screen 210 illustrates a display to the end user under normal operation when neither the first and second data sets are in control—the relay is set to on and normal power is supplied to the appliance. The user has four options in this situation, do nothing, press OFF, press PROGRAM, and press ESPANOL. If the end user presses ESPANOL all of the menus switch to Spanish (not shown). If end user presses OFF display screen 210 changes to screen 220, which informs end user that the water is not heating. Display screen 220 gives the user options of ON, PROGRAM, and ESPANOL.

When the programmable energy saving timer is under the control of the first data set and thus the relay has been switched off display screen 230 is presented to end user. End user is told that the water is not heating and that it is under the control of a property owner or an energy utility, in this example a company named Austin Energy. The end user in this case has an additional option of pressing RESUME, which provides the override function previously discussed. If RESUME is pressed display screen 240 is presented to the end user, which communicates that the energy utility control has been by-passed. As described earlier this override capability is limited to one time per day and to a prescribed period, for example one hour.

Menu screen 250 exhibits a display during a time period in which the first data set is not in control and the second data set is in control. In this case the water is not heating because the end user has specified this time period as one in which energy is to be saved. The options are now ON, PROGRAM, RESUME, and ESPANOL.

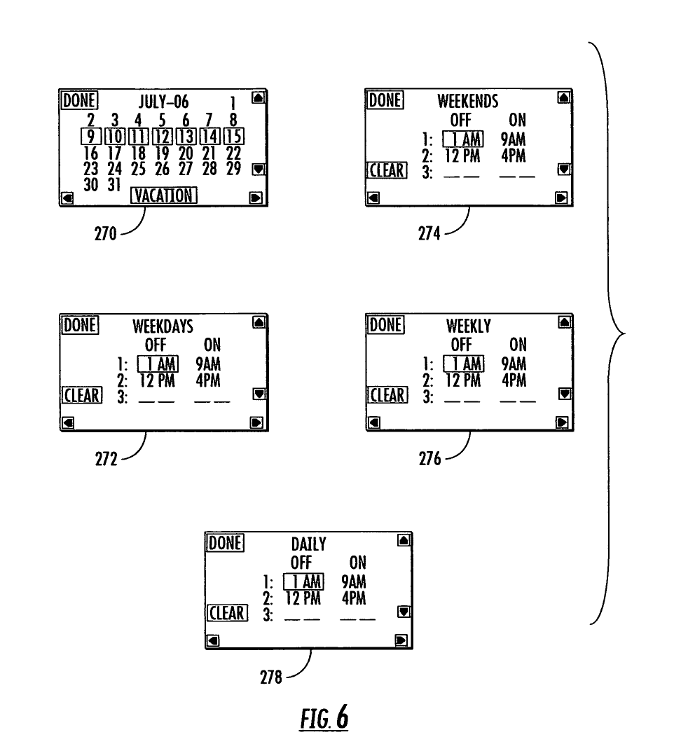

In any of the screen modes of FIG. 4 the PROGRAM button can be pressed. When this is done the software of the instant invention displays menu screen 260 of FIG. 5. Menu screen 260 displays programming options for the end user. The options are VACATION, DAILY, WEEKLY, WEEKENDS, and WEEKDAYS. Up and down toggle buttons 262 on the one side of the display allow the end user to move around on the menu and then SELECT the (such as 105 of FIG. 1) of a programmable energy saving timer. An enclosure 162 protects the internals, which include an electrical service disconnect 164 and the control electronics 168. The relay (104 of FIG. 1) is not visible in FIG. 3 but is also included in such a base unit.

FIG. 4 exhibits, via a series of menu screen display, the operation of the user interface in a preferred embodiment of the instant invention if it is being used to heat water. It is assumed in FIG. 4 that the end user has already programmed the energy saving timer so there is a second data set available to the controller defining prescribed times of energy savings. A first display screen 210 illustrates a display to the end user under normal operation when neither the first and second data sets are in control—the relay is set to on and normal power is supplied to the appliance. The user has four options in this situation, do nothing, press OFF, press PROGRAM, and press ESPANOL. If the end user presses ESPANOL all of the menus switch to Spanish (not shown). If end user presses OFF display screen 210 changes to screen 220, which informs end user that the water is not heating. Display screen 220 gives the user options of ON, PROGRAM, and ESPANOL.

When the programmable energy saving timer is under the control of the first data set and thus the relay has been switched off display screen 230 is presented to end user. End user is told that the water is not heating and that it is under the control of a property owner or an energy utility, in this example a company named Austin Energy. The end user in this case has an additional option of pressing RESUME, which provides the override function previously discussed. If RESUME is pressed display screen 240 is presented to the end user, which communicates that the energy utility control has been by-passed. As described earlier this override capability is limited to one time per day and to a prescribed period, for example one hour.

Menu screen 250 exhibits a display during a time period in which the first data set is null and the second data set is in control. In this case the water is not heating because the end user has specified this time period as one in which energy is to be saved. The options are now ON, PROGRAM, RESUME, and ESPANOL.

In any of the screen modes of FIG. 4 the PROGRAM button can be pressed. When this is done the software of the instant invention displays menu screen 260 of FIG. 5. Menu screen 260 displays programming options for the end user. The options are VACATION, DAILY, WEEKLY, WEEKENDS, and WEEKDAYS. Up and down toggle buttons 262 on the one side of the display allow the end user to move around on the menu and then SELECT the aspect of future time periods to program. Selecting one of the options moves the end user to additional screens (FIG. 6) that allow straightforward choosing of dates and times for inclusion in the second data set that defines the end users desires.

FIG. 6 is a summary of the final programming screens available to the end user. The end user can program future vacations 270, weekends 274, weekdays 272, weeks 276, or days 278. Once the dates and times are selected and the user presses DONE to advance back to the main menu all of the chosen dates and times become part of the second data set.

The first data set, which includes the utility provider's desired on and off times, may be programmed into the energy saving timer before it is shipped to the end user. Alternately the utility company may wish to occasionally change this first data set programming in the field. Since programming this first data set from the user interface would require a special access code or physical key and might be subject to error from the service personnel, an alternate approach is preferred. A preferred embodiment is to do this with a portable programming unit that field service personnel can simply plug into the timer to reprogram. This portable programming unit could take several forms, including a laptop computer, a small dedicated microprocessor, or a memory storage device such as a passive memory chip already pre-programmed with a first data set. In the case of a passive memory chip the system software of the programmable energy saving timer will be able to read and store values from such a device. And the system software can be designed so that it can only receive a first data set from such a memory storage device. A special version of the main control program of the programmable energy saving timer could be provided to the utility provider to program the passive memory chip from a central office. A preferred embodiment of such a passive memory chip is a dongle that resembles a USB compatible memory chip that plugs directly into the programmable energy saving timer. An aspect of this embodiment is illustrated in FIG. 1 in which service personnel can plug such a dongle 112 into a receptacle 114 in user interface 102. The information on the dongle can be encrypted and have a proprietary check-sum algorithm applied to ensure data integrity.

One aspect of the programmable energy saving timer is that it defaults to English as its user interface language but Spanish is also supported. After installation, the owner of the new timer can change from English to Spanish with a single button press on a button labeled “ESPANOL” on the main user-interface screen. If the user enters Spanish mode, the button labeled ESPANOL will change to ENGLISH (not shown) and the unit can be switched back to English by pressing the button again.

Another aspect of the programmable energy saving timer is that if the end user has not pressed a button on the unit for more than 30 seconds, the screen will be dimmed to a low but still visible intensity level to maximize the lifetime of the display and to reduce power consumption.

Another aspect of the programmable energy saving timer is that the device will monitor the voltage level on the power supply and the current used by the load for warranty purposes. If the supply voltage should exceed 250 VAC or the load should draw more than 30 A, it will record a time-stamped event into memory that may be seen when a valid dongle is plugged into the device. Recorded events will not be erased so that they may also be viewed if the unit is shipped back to the factory.

Another aspect of the programmable energy saving timer is tamper protection. Two sensors monitor access to portions of the timer inside the enclosure. If the front panel is removed, a time-stamped event is recorded. If the enclosure is taken apart to expose the microprocessor control area, the unit will cease to function and will display a message to contact the Utility Company for service. This message will be programmed into the unit at the factory but may be changed in the field through the use of the dongle as described below. If the microprocessor area has been tampered with, the unit will need to be returned to the factory to re-enable operation. In alternate industrial designs more or fewer sensors could be used to further monitor system tampering.

While the invention has been described above with references to specific embodiments thereof, it is apparent that many changes, modifications and variations in the materials, arrangements of parts and steps can be made without departing from the inventive concept disclosed herein. Accordingly, the spirit and broad scope of the appended claims are intended to embrace all such changes, modifications and variations that may occur to one of skill in the art upon a reading of the disclosure.

1. A programmable energy saving timer for use by an end user for delivering power to an end use comprising:
a. a relay for on and off switching of power to the end use;
b. a user interface; and
c. a controller with associated control software in communication with said relay, and said user interface;
wherein the controller with associated control software operates based on a first data set and a second data set;
and wherein the first data set is programmed into the controller by a first entity; and
the second data set is programmed into the controller by the end user using the user interface.

2. The programmable energy saving timer of claim 1 wherein the first entity is a utility provider supplying electrical power.

3. The programmable energy saving timer of claim 1 wherein the first entity is a property owner supplying power to multiple end users.

4. The programmable energy saving timer of claim 1 wherein the first data set is a null set.

5. The programmable energy saving timer of claim 1 wherein a portable programming unit connects to said programmable energy saving timer and provides the first data set.

6. The programmable energy saving timer of claim 5 wherein the portable programming unit is a memory storage device.

7. The programmable energy saving timer of claim 1 wherein the energy saving timer is enclosed and wherein if the enclosure is opened to allow access to either the electrical connections or to the controller then one or more sensors record that opening in said controller with associated control software.

8. The programmable energy saving timer of claim 1 wherein said user interface is configured in a first module and said first module communicates with a second module containing said relay for on and off switching of power to the end use and said controller with associated control software.

9. The programmable energy saving timer of claim 8 wherein said communication between said first module and said second module is made by wireless communication.

10. The programmable energy saving timer of claim 9 wherein said wireless communication is accomplished by a radio frequency (RF) link.

11. The programmable energy saving timer of claim 8 wherein said second module is positioned near said end use and contains an integral means of electrical service disconnect.

12. A method of switching on and off a power source to an end use comprising the steps of:
providing a first data set of times in which the power is switched off;
providing a second data set of times in which the power is switched off; and
switching the power source off at times dictated by said first and second data sets;
wherein the first data set is provided by a first entity; and
the second data set is provided by an end user of said end use.

13. The method of claim 12 wherein the first entity is a utility provider supplying electrical power.

14. The method of claim 12 wherein the first entity is a property owner supplying power to multiple end users.

15. The method of claim 12 wherein the first data set is input by a portable programming unit.

16. The method of claim 15 wherein the portable programming unit is a memory storage device.

17. The method of claim 12 wherein the second data set is programmed by said end user using a user interface.
